(19) United States
(12) Patent Application Publication
(10) Pub. No.: US 2013/0106337 A1
(43) Pub. Date: May 2, 2013

(54) APPARATUS OF DRIVING WHEELS FOR IN-WHEEL SYSTEM

(71) Applicants: Changsung Sean Kim, Gyunggi-do (KR); Guen Hong Lee, Seoul (KR); Hong Chul Shin, Gyunggi-do (KR); Han Tae Kim, Gyuggi-do (KR); Han Kyung Bae, Gyunggi-do (KR)

(72) Inventors: Changsung Sean Kim, Gyunggi-do (KR); Guen Hong Lee, Seoul (KR); Hong Chul Shin, Gyunggi-do (KR); Han Tae Kim, Gyuggi-do (KR); Han Kyung Bae, Gyunggi-do (KR)

(73) Assignee: SAMSUNG ELECTRO-MECHANICS CO., LTD., Gyunggi-do (KR)

(21) Appl. No.: 13/403,876

(22) Filed: Feb. 23, 2012

(30) Foreign Application Priority Data
Oct. 31, 2011 (KR) 1020110112307

(51) Int. Cl. H02P 6/08; H02K 16/02; H02P 6/14

(52) U.S. Cl. 318/701; 318/434; 310/114

(57) ABSTRACT

Disclosed herein are an apparatus and a method of driving a switched reluctance motor. The apparatus includes: a power supply unit; N pairs of coils; N pairs of upper switch devices each connected in series with an upper portion of each of the N pairs of coils; N pairs of lower switch devices each connected in series with a lower portion of each of the N pairs of coils; 2N first freewheel diodes; 2N second freewheel diodes; and a switch driving unit providing a control signal to the N pairs of upper switch devices and the N pairs of lower switch devices to sequentially supply current to the N pairs of coils.

### CROSS REFERENCE TO RELATED APPLICATION

This application claims the benefit of Korean Patent Application No. 10-2011-0112307, filed on Oct. 31, 2011, entitled “Drive Apparatus for switched Reluctance Motor and method thereof”, which is hereby incorporated by reference in its entirety into this application.

### BACKGROUND OF THE INVENTION

1. Technical Field

The present invention relates to an apparatus and a method of driving a switched reluctance motor.

2. Description of the Related Art

Recently, the demand for a motor has largely increased in various industries such as vehicles, aerospace, military, medical equipment, or the like. In particular, a cost of a motor using a permanent magnet is increased due to a sudden increase in price of a rare earth material, such that a switched reluctance motor (SRM) has become interested as a new alternative.

A driving principle of the switched reluctance motor rotates a rotor using a reluctance torque generated according to a change in magnetic reluctance.

As shown in FIG. 1, a switched reluctance motor 1 according to the prior art includes a rotor 11 and a stator 12, wherein the rotor 11 is provided with a plurality of rotor salient poles 11-1 and the stator 12 is provided with a plurality of stator salient poles 12-1 facing the rotor salient poles 11-1. Further, a coil 13 is wound around the stator salient poles 12-1.

Further, the rotor 11 is configured only of an iron core without any excitation device, for example, a winding of a coil or a permanent magnet.

Therefore, when current flows in the coil 13 from the outside, a reluctance torque moving the rotor 11 toward the coil 13 by magnetic force generated from the coil 13 is generated, such that the rotor 11 rotates in a direction in which resistance of a magnetic circuit is minimized.

However, the switched reluctance motor 1 according to the prior art may lead to core loss since a magnetic flux passes through both of the stator 12 and the rotor 11 at the time of driving of the switched reluctance motor 1.

In order to solve the problem of the prior art as described above, a double rotor type switched reluctance motor including an in-rotor and an out-rotor, which is an advanced technology, has been developed.

However, even in the case of this advanced technology, it is difficult to efficiently perform a weak field control since an asymmetric half bridge type driving apparatus using six switches according to the prior art is still being used in order to perform a driving control.

### PRIOR ART DOCUMENT

### Patent Document

(Patent Document 1) Korean Patent Laid-Open Publication No. 10-2008-0054495

### SUMMARY OF THE INVENTION

The present invention has been made in an effort to provide an apparatus and a method of driving a switched reluctance motor capable of implementing efficient driving in a weak field by individually driving an in-rotor and an out-rotor.

According to a preferred embodiment of the present invention, there is provided an apparatus of driving a switched reluctance motor, the apparatus including: a power supply unit supplying direct current (DC) current; N pairs of coils each inducing a magnetic field according to the current supplied from the power supply unit to provide driving force to the switched reluctance motor and connected in parallel with each other; N pairs of upper switch devices each connected in series with an upper portion of each of the N pairs of coils to open or close the DC current supplied from the power supply unit; N pairs of lower switch devices each connected in series with a lower portion of each of the N pairs of coils to open or close current passing through the N pairs of coils; 2N first freewheel diodes each having one terminal connected to a connection point between the lower portion of each of the N pairs of coils and each of the N pairs of lower switch devices and the other terminal connected to a power supply terminal; 2N second freewheel diodes each connected between the upper portion of each of the N pairs of coils and a ground; and a switch driving unit providing a driving control signal to the N pairs of upper switch devices and the N pairs of lower switch devices to sequentially supply the current to the N pairs of coils.

The apparatus may further include a capacitor smoothing the DC current supplied from the power supply unit to supply the smoothed DC current to the N pairs of coils and charged with residual current of the N pairs of coils at the time of turn-off of the N pairs of upper switch devices and the N pairs of lower switch devices

The switch driving unit may detect revolutions per minute (RPM) of the switched reluctance motor and control the power supply unit to allow maximum power to be supplied when the RPM of the switched reluctance motor is smaller than a first reference number.

The switch driving unit may detect the RPM of the switched reluctance motor and control the power supply unit to allow rated power to be supplied when the RPM of the switched reluctance motor is larger than the first reference number.

The switch driving unit may detect the RPM of the switched reluctance motor and provide the driving control signal to the N pairs of upper switch devices and the N pairs of lower switch devices so that the current flows only in any one coil of each pair of coils with respect to the N pairs of coils when the RPM of the switched reluctance motor is larger than a second reference number.

The switched reluctance motor may include: an out-rotor provided with a plurality of salient poles protruded at equidistance along an inner peripheral surface thereof; an in-rotor provided with a plurality of salient poles protruded at equidistance along an outer peripheral surface thereof; and a stator provided in the out-rotor, having the in-rotor rotatably provided at an inner peripheral portion thereof, and a plurality of out-stator cores each including a pair of out-stator salient poles protruded toward the salient pole of the out-rotor and an out-stator yoke connecting the pair of out-stator salient poles to each other and supporting the pair of out-stator salient poles and a plurality of in-stator cores each including a pair of in-stator salient poles protruded toward the salient pole of the in-rotor and an in-stator yoke connecting the pair of in-stator salient poles to each other and supporting the pair of in-stator salient poles, and each of the N pairs of coils may be wound around the out-stator salient poles and the in-stator salient poles.

The out-stator core may have a pi (π) shape.

Six out-stator cores may be formed at equipitch along an outer peripheral surface of the stator in a circumferential direction thereof; six in-stator cores may be formed at equipitch along an inner peripheral surface of the stator in the circumferential direction thereof; each of the coils may be wound around the out-stator salient poles and the in-stator salient poles to form a three-phase winding, ten salient poles of the out-rotor may be formed at equipitch in a circumferential direction of the out-rotor, and ten salient poles of the in-rotor may be formed at equipitch in a circumferential direction of the in-rotor.

According to another preferred embodiment of the present invention, there is provided a method of driving a switched reluctance motor, the method including: (A) controlling, in the switch driving unit, N pairs of upper switch devices each connected in series with an upper portion of each of N pairs of coils of the switched reluctance motor and N pairs of lower switch devices each connected in series with a lower portion of each of the N pairs of coils to apply a separation pulse to the N pairs of coils, thereby starting up the switched reluctance motor; and (B) controlling, in the switch driving unit, the N pairs of upper switch devices and the N pairs of lower switch devices to supply maximum current to the N pairs of coils of the switched reluctance motor, thereby rotating the switched reluctance motor.

The method may further include, before step (A), (C) controlling, in the switch driving unit, the N pairs of upper switch devices and the N pairs of lower switch devices to initially align the switch reluctance motor when power is supplied from a power supply unit.

The method may further include, after step (C), (D) providing a predetermined blank time so that a rotor of the switched reluctance motor is positioned at a normal parking position.

The method may further include: (E) detecting, in the switch driving unit, RPM of the switched reluctance motor and comparing the RPM of the switched reluctance motor with a first reference number; and (F) controlling, in the switch driving unit, a power supply unit to supply rated current to the N pairs of coils when the RPM of the switched reluctance motor is larger than the first reference number.

The method may further include: (G) detecting, in the switch driving unit, the RPM of the switched reluctance motor and comparing the RPM of the switched reluctance motor with a second reference number; and (H) controlling, in the switch driving unit, the N pairs of upper switch devices and the N pairs of lower switch devices so that current flows only in any one coil of each pair of coils with respect to the N pairs of coils when the RPM of the switched reluctance motor is larger than the second reference number.

### BRIEF DESCRIPTION OF THE DRAWINGS

FIG. 1 is a schematic cross-sectional view of a switched reluctance motor according to the prior art;

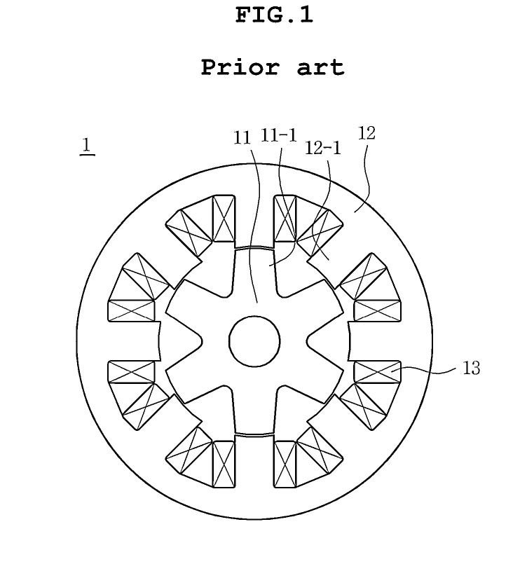

FIG. 2 is a circuit diagram of an apparatus of driving a switched reluctance motor according to a first preferred embodiment of the present invention;

FIG. 3 is a waveform diagram of a gate signal output from a switch driving unit of FIG. 2 in a high torque period and a high efficiency period;

FIG. 4 is a waveform diagram of an example of a gate signal output from the switch driving unit of FIG. 2 in a high speed period;

FIG. 5 is a waveform diagram of another example of a gate signal output from the switch driving unit of FIG. 2 in a high speed period;

FIG. 6 is a schematic cross-sectional view of a switched reluctance motor to which the apparatus of driving a switched reluctance motor according to the first preferred embodiment of the present invention is applied;

FIG. 7 is a perspective view of the switched reluctance motor shown in FIG. 6; and

FIG. 8 is a flow chart of a method of driving a switched reluctance motor according to the first preferred embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Various objects, advantages and features of the invention will become apparent from the following description of embodiments with reference to the accompanying drawings. In the specification, in adding reference numerals to components throughout the drawings, it is to be noted that like reference numerals designate like components even though components are shown in different drawings. Further, terms used in the specification, ‘first’, ‘second’, etc. can be used to describe various components, but the components are not to be construed as being limited to the terms. The terms are only used to differentiate one component from other components. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

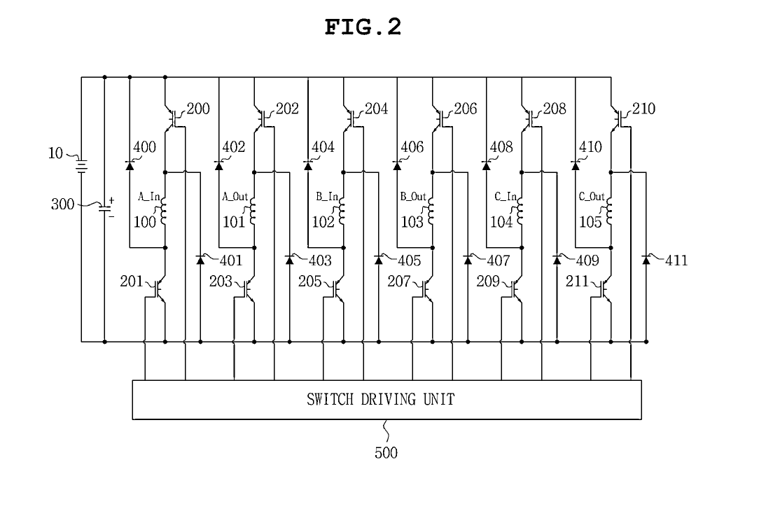

FIG. 2 is a circuit diagram of an apparatus of driving a switched reluctance motor according to a first preferred embodiment of the present invention.

Referring to FIG. 2, the apparatus of driving a switched reluctance motor according to the first preferred embodiment of the present invention is configured to include three in-coils and three out-coils, more specifically, a first phase in-coil 100, a first phase out-coil 101, a second phase in-coil 102, a second phase out-coil 103, a third phase in-coil 104, and a third phase out-coil 105.

In addition, the apparatus of driving a switched reluctance motor is configured to include three pairs of in-switches and three pairs of out-switches. More specifically, first phase in-switch devices 200 and 201 are connected in series with each other, first phase-switch devices 202 and 203 are connected in series with each other, second phase in-switch devices 204 and 205 are connected in series with each other, second phase out-switch devices 206 and 207 are connected in series with each other, third phase in-switch devices 208 and 209 are connected in series with each other, and third phase out-switch devices 210 and 211 are connected in series with each other.

This switch may be implemented as a metal oxide semiconductor field effect transistor (MOSFET) device, a bipolar junction transistor (BJT) device, a relay switch device, or the like. According to the first preferred embodiment of the present invention, the switch is implemented as the MOSFET device.

In addition, the apparatus of driving a switched reluctance motor includes a capacitor 300 smoothing power supplied from a power supply unit 10, charged with residual current at the time of turn-off of the first to third phase switch devices 200 to 211 after the first to third phase coils 100 to 105 and the first to third phase switch devices 200 to 211 operate and connected in parallel with circuits each including upper switch devices 200, 202, 204, 206, 208, and 210, lower switch devices 201, 203, 205, 207, 209, and 211 and the first to third phase coils 100 to 105.

Further, the apparatus of driving a switched reluctance motor includes first freewheel diodes 400, 402, 404, 406, 408, and 410 each connected between a supply terminal of the power supply unit 10 and drains of the lower switch devices 201, 203, 205, 207, 209, and 211 and second freewheel diodes 401, 403, 405, 407, 409, and 411 each connected between sources of the upper switch devices 200, 202, 204, 206, 208, and 210 and a ground (GND).

In addition, the apparatus of driving a switched reluctance motor includes a switch driving unit 500 controlling turn-on or turn-off of the upper switch devices 200, 202, 204, 206, 208, and 210 and the lower switch devices 201, 203, 205, 207, 209, and 211.

In this configuration, the capacitor 300 smoothes power input from the power supply unit 10 to supply the smoothed direct current voltage to the SRM.

In addition, the capacitor 300 is charged with residual current at the time of turn-off of the first to third phase switch devices 200 to 211 after the first to third phase coils 100 to 105 and the first to third phase switch devices 200 to 211 operate, thereby removing the residual current in the first to third phase coils 100 to 105.

Further, the first phase in-switch devices 200 and 201 are turned on or turned off according to a driving control signal output from the switch driving unit 500 in order to rotate the SRM in a forward direction or a reverse direction according to a rotor position signal of the SRM. When the first phase in-switch devices 200 and 201 are turned on, they supply the voltage supplied from the power supply unit 10 to the first in-coil 100.

Likewise, the first phase out-switch devices 202 and 203 are turned on or turned off according to the driving control signal output from the switch driving unit 500 in order to rotate the SRM in the forward direction or the reverse direction according to the rotor position signal of the SRM. When the first phase out-switch devices 202 and 203 are turned on, they supply the voltage supplied from the power supply unit 10 to the first out-coil 101.

Further, the second phase in-switch devices 204 and 205 are turned on or turned off according to the driving control signal output from the switch driving unit 500 in order to rotate the SRM in the forward direction or the reverse direction according to the rotor position signal of the SRM. When the second phase in-switch devices 204 and 205 are turned on, they supply the voltage supplied from the power supply unit 10 to the second in-coil 102.

Likewise, the second phase out-switch devices 206 and 207 are turned on or turned off according to the driving control signal output from the switch driving unit 500 in order to rotate the SRM in the forward direction or the reverse direction according to the rotor position signal of the SRM. When the second phase out-switch devices 206 and 207 are turned on, they supply the voltage supplied from the power supply unit 10 to the second out-coil 103.

Further, the third phase in-switch devices 208 and 209 are turned on or turned off according to the driving control signal output from the switch driving unit 500 in order to rotate the SRM in the forward direction or the reverse direction according to the rotor position signal of the SRM. When the third phase in-switch devices 208 and 209 are turned on, they supply the voltage supplied from the power supply unit 10 to the third in-coil 104. Likewise, the third phase out-switch devices 210 and 211 are turned on or turned off according to the driving control signal output from the switch driving unit 500 in order to rotate the SRM in the forward direction or the reverse direction according to the rotor position signal of the SRM. When the third phase out-switch devices 210 and 211 are turned on, they supply the voltage supplied from the power supply unit 10 to the third out-coil 105.

Meanwhile, each of the first freewheel diodes 400, 402, 404, 406, 408, and 410 and the second freewheel diodes 401, 403, 405, 407, 409, and 411 provides a current path so that residual current induced in the respective phase in-coils or out-coils 100 to 105 is charged in the capacitor 300 when the switch devices 200 to 211 corresponding thereto are turned off, thereby allowing the residual current induced in the respective phase in-coils or out-coils 100 to 105 to be removed.

In addition, the switch driving unit 500 generates the driving control signal for rotating the SRM in the forward direction or the reverse direction according to the rotor position signal of the SRM to sequentially control the turn-on or turn-off of the upper switch devices 200, 202, 204, 206, 208, and 210 and the lower switch devices 201, 203, 205, 207, 209, and 211.

An operation of the apparatus of driving a switched reluctance motor configured as described above will be described below.

First, the capacitor 300 supplies direct current voltage generated by smoothing the power input from the power supply unit 10 to the SRM.

Therefore, the SRM rotates. Accordingly, a photo interrupter and a disk having a slot associated with each phase are installed at an inner portion of the motor, such that a position of the rotor is detected by a photo sensor.

Therefore, the switch driving unit 500 supplies a first phase driving control signal having a high state to each of gates of the first phase upper and lower switch devices 200 to 203 connected in series with the first phase coils 100 and 101 so that magnetic fields may be induced in the first phase coils 100 and 101.

In this case, the first phase upper and lower switch devices 200 to 203 are simultaneously turned on.

As described above, since the first phase upper and lower switch devices 200 to 203 are turned on, current flows in the first phase coils 100 and 101, such that the magnetic fields are induced in the first phase coils 100 and 101.

After the current flows in the first phase coils 100 and 101 as described above, the switch driving unit 500 outputs a driving control signal having a low state to the first phase upper and lower switch devices 200 to 203.

Therefore, the first phase upper and lower switch devices 200 to 203 are simultaneously turned off, and residual current generated by the magnetic fields induced in the first phase coils 100 and 101 is removed by the first freewheel diodes 400 and 402, the capacitor 300, the second freewheel diodes 401 and 403, and the first phase coils 100 and 101, such that the motor smoothly rotates.

Then, the switch driving unit 500 supplies a second phase driving control signal having a high state to each of gates of the second phase upper and lower switch devices 204 to 207 connected in series with the second phase coils 102 and 103 so that magnetic fields may be induced in the second phase coils 102 and 103.

In this case, the second phase upper and lower switch devices 204 to 207 are simultaneously turned on.

Since the second phase upper and lower switch devices 204 to 207 are turned on, current flows in the second phase coils 102 and 103, such that the magnetic fields are induced in the second phase coils 102 and 103.

After the current flows in the second phase coils 102 and 103 as described above, the switch driving unit 500 outputs a driving control signal having a low state to the second phase upper and lower switch devices 204 to 207.

Therefore, the second phase upper and lower switch devices 204 to 207 are simultaneously turned off, and residual current generated by the magnetic fields induced in the second phase coils 102 and 103 is removed by the first freewheel diodes 404 and 406, the capacitor 300, the second freewheel diodes 405 and 407, and the second phase coils 102 and 103, such that the motor smoothly rotates.

Further, also in the case of a third phase, the above-mentioned operation is performed. The above-mentioned operation is repeated, such that the SRM rotates.

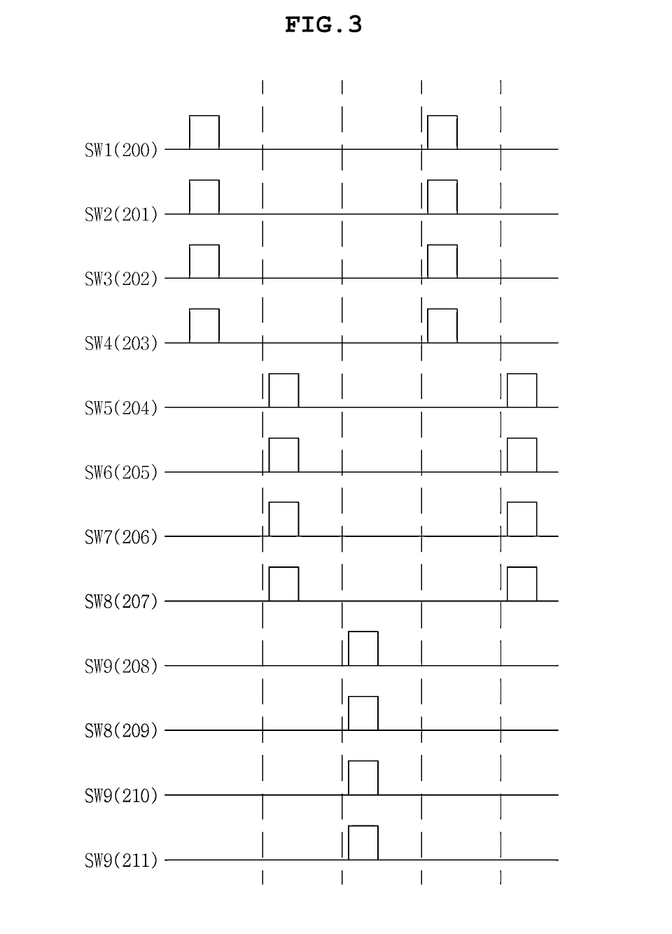

Meanwhile, in a high torque period, for example, in a period in which revolutions per minute (RPM) of the motor is 0 to 200 rpm, the switch driving unit 500 sequentially turns on the respective phase switch devices 200 to 211 to supply the current to the respective phase in-coils 100, 102, and 104 and the respective phase out-coils 101, 103, and 105, thereby inducing the magnetic fields, as shown in FIG. 3.

At this time, the switch driving unit 500 controls the power supply unit 10 to supply maximum current (for example, the maximum current may be in a range of 200 to 300 A in the case in which rated current is 70A at voltage of 144 V) to the respective phase in-coils 100, 102, and 104 and the respective phase out-coils 101, 103, and 105, thereby inducing the magnetic field.

As described above, when the maximum current is supplied to the respective phase in-coils 100, 102, and 104 and the respective phase out-coils 101, 103, and 105, a torque of the SRM is in proportion to the supplied current, such that a high torque may be maintained.

In the SRM, it is difficult to increase a speed as the torque increases. The reason is that a residual torque is generated due to the residual current in a period in which the respective phase switch devices 200 to 211 corresponding to the respective phase in-coils 100, 102, and 104 and the respective phase out-coils 101, 103, and 105 are turned off, the generated residual torque acts as resistive force against rotational force of the rotor.

The residual current and the residual torque are in proportion to applied current in a period in which the respective phase switch devices 200 to 211 are turned on.

That is, the reason is that when the applied current in the period in which the respective phase switch devices 200 to 211 are turned on becomes the maximum current, the residual current in a state in which the respective phase switch devices 200 to 211 are turned off also becomes the maximum to generate the maximum resistive force against the rotational force of the motor.

Next, in a high efficiency period in which a torque decreases but a speed increases, for example, in a period in which RPM of the motor is 200 to 600 rpm, the switch driving unit 500 sequentially turns on the respective phase switch devices 200 to 211 to supply the current to the respective phase in-coils 100, 102, and 104 and the respective phase out-coils 101, 103, and 105, thereby inducing the magnetic fields, as shown in FIG. 3.

At this time, the switch driving unit 500 controls the power supply unit 10 to supply rated current (for example, 70A) to the respective phase in-coils 100, 102, and 104 and the respective phase out-coils 101, 103, and 105.

As described above, when the rated current is supplied to the respective phase in-coils 100, 102, and 104 and the respective phase out-coils 101, 103, and 105, a torque decreases as compared to when the maximum current is supplied; however, a speed may be maintained to be higher than a speed in the high torque period.

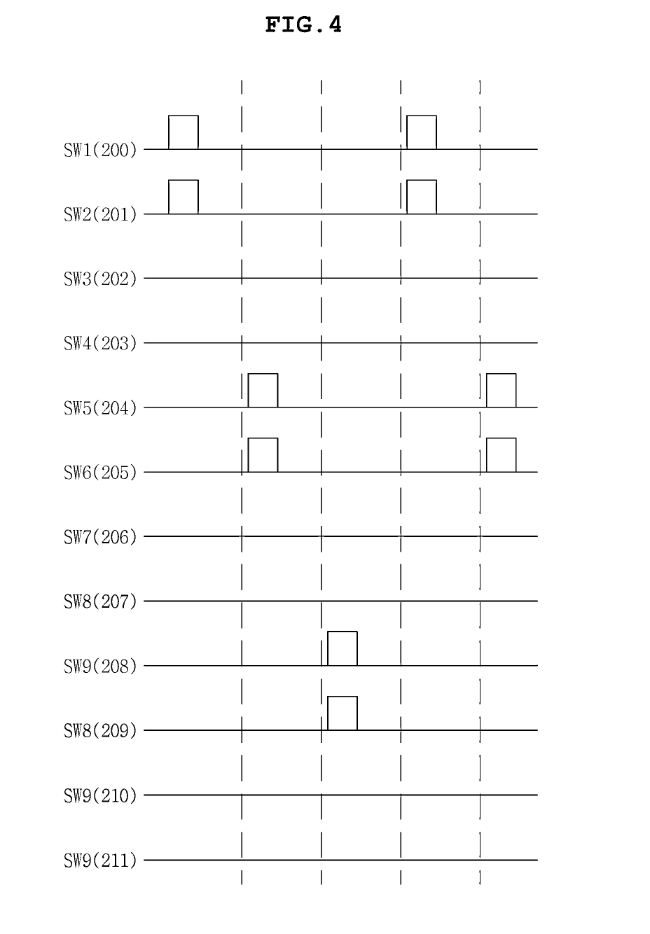

In addition, in a high speed period in which a torque decreases but a speed increases, as compared to the high efficiency period, for example, in a period in which RPM of the motor is 600 to 1000 rpm, the switch driving unit 500 sequentially turns on the in-switch devices 200, 201, 204, 205, 210, and 211 among the respective phase switch devices 200 to 211 and turns off the out-switch devices 202, 203, 206, 207, 210, and 211 among them to supply the current to only the respective phase in-coils 100, 102, and 104, thereby inducing the magnetic fields, as shown in FIG. 4.

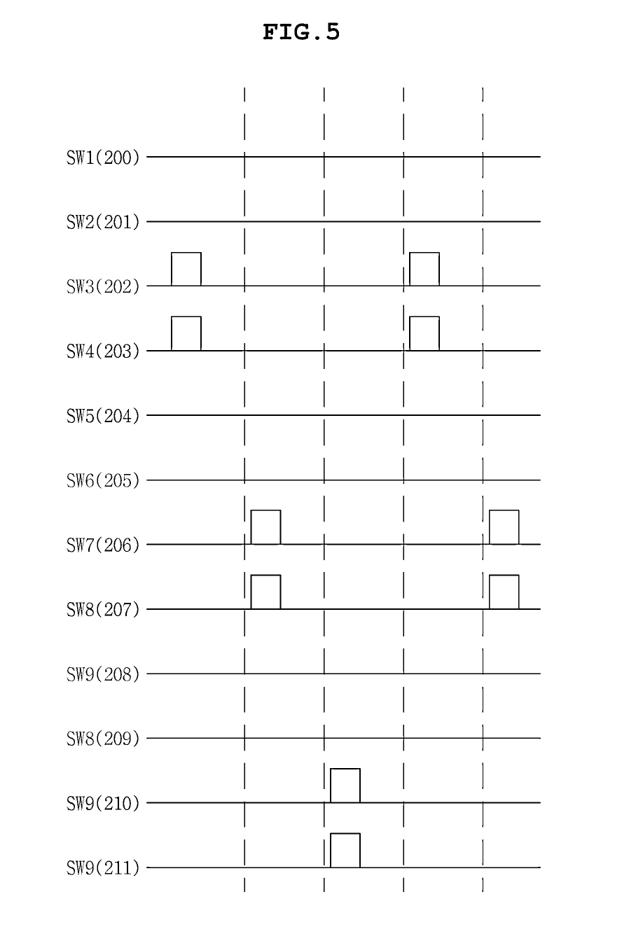

Unlike this, in the high speed period, the switch driving unit 500 turns off the in-switch devices 200, 201, 204, 205, 210, and 211 among the respective phase switch devices 200 to 211 and sequentially turns on the out-switch devices 202, 203, 206, 207, 210, and 211 among them to supply the current to only the respective phase out-coils 101, 103, and 105, thereby inducing the magnetic fields, as shown in FIG. 5.

At this time, the switch driving unit 500 controls the power supply unit 10 to supply the rated current (for example, 70A) to the respective phase in-coils 100, 102, and 104 or the respective phase out-coils 101, 103, and 105.

As described above, when the rated current is supplied to only any one of the respective phase in-coils 100, 102, and 104 and the respective phase out-coils 101, 103, and 105, a current supply amount decreases as compared to when the rated current is supplied to both of the respective phase in-coils 100, 102, and 104 and the respective phase out-coils 101, 103, and 105, such that a torque may further decrease but a speed may be maintained to be higher than a speed in the high efficiency period.

As set forth above, according to the preferred embodiment of the present invention, since the in-rotor and the out-rotor are individually driven, a control may be optimally performed for each period according to a driving state including the high torque period, the high efficiency period, and the high speed period.

Particularly, according to the preferred embodiment of the present invention, only any one of the in-rotor and the out-rotor is driven in the high speed period, such that efficient driving may be performed.

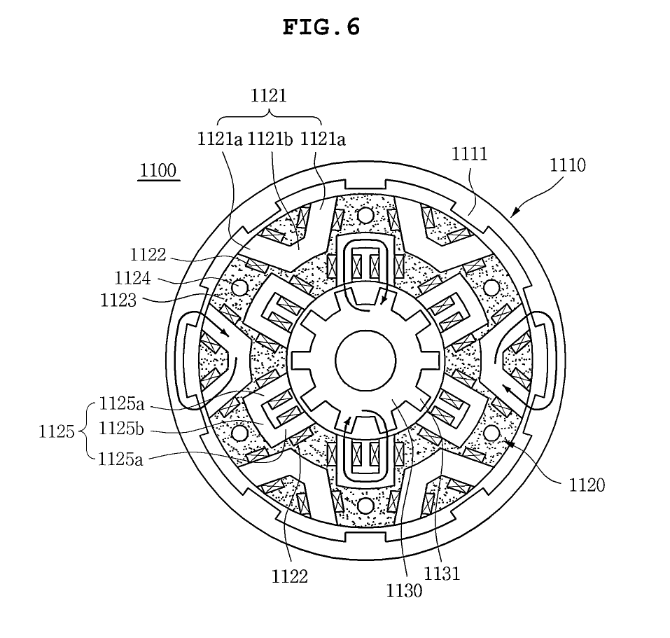

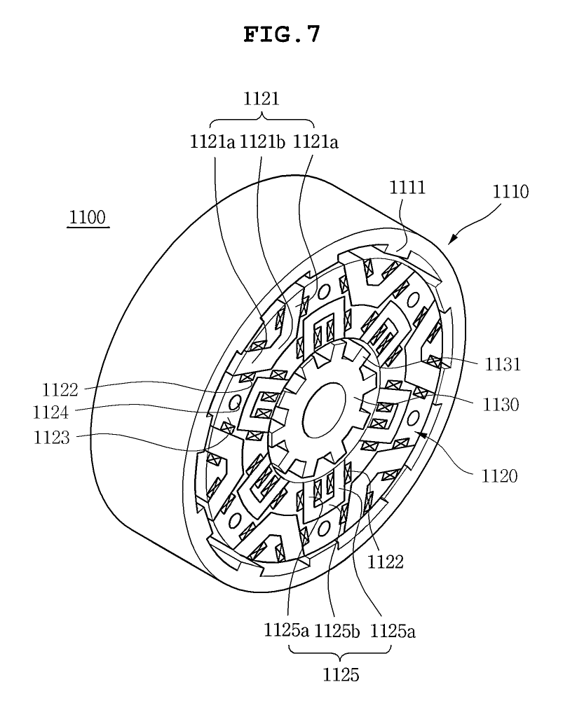

FIG. 6 is a schematic cross-sectional view of a switched reluctance motor to which the apparatus of driving a switched reluctance motor according to the first preferred embodiment of the present invention is applied; and FIG. 7 is a perspective view of the switched reluctance motor shown in FIG. 6.

As shown, the switched reluctance motor 1100 is a double rotor type switched reluctance motor including an out-rotor 1110, a stator 1120, and an in-rotor 1130.

The out-rotor 1110 is positioned at an outer peripheral portion of the stator 1120, the in-rotor 1130 is rotatably positioned at an inner peripheral portion of the stator 1120, and each of the out-rotor 1110 and the in-rotor 1130 rotates in one direction by a reluctance torque with the stator 1120.

More specifically, the out-rotor 1110 is provided with a plurality of salient poles 1111 protruded at equidistance along an inner peripheral surface thereof In addition, the in-rotor 1130 is provided with a plurality of salient poles 1131 protruded at equidistance along an outer peripheral surface thereof.

Further, the stator 1120 is provided in the out-rotor 1110 and includes a plurality of out-stator cores 1121, coils 1122, supports 1123, cooling pipes 1124, and in-stator cores 1125.

The out-stator core 1121 includes a pair of out-stator salient poles 1121a protruded toward the salient pole 1111 of the out-rotor 1110 and an out-stator yoke 1121b connecting one end portions of the pair of out-stator salient poles 1121a to each other and supporting the one end portions of the pair of out-stator salient poles 1121a and has a pi (π) shape.

In addition, each of the coils 1122 is wound around the pair of out-stator salient poles 1121a.

The in-stator core 1125 includes a pair of in-stator salient poles 1125a protruded toward the salient pole 1131 of the in-rotor 1130 and an in-stator yoke 1125b connecting one end portions of the pair of in-stator salient poles 1125a to each other and supporting the one end portions of the pair of in-stator salient poles 1125a and has a pi (π) shape. In addition, the pair of in-stator salient poles 1125a is disposed to be in parallel with each other. Through the above-mentioned configuration, it is possible to prevent a direction of magnetic flux from being deflected toward both side directions of the in-stator salient pole 1125a.

In addition, each of the coils 1122 is wound around the pair of in-stator salient poles 1125a.

Further, the support 1123 is filled in between the plurality of out-stator cores 1121, between the in-stator cores 1125, between the out-stator salient poles 1121a having the coil 1122 wound therearound, and between the in-stator salient poles 1125a having the coil 1122 wound therearound. In addition, the support improves strength of the stator 1120 and reduces noise and vibration. Further, the support is made of a non-magnetic material or an insulating material.

The cooling pipe 1124, which is to radiate heat generated due to a high speed operation, is positioned between the plurality of out-stator cores 1121 in a state in which it is inserted into the support 1123. In addition, the cooling pipe 1124 may be implemented as a water cooling pipe in which water flows.

Through the above-mentioned configuration, in the switched reluctance motor 1100 according to the preferred embodiment of the present invention, the magnetic flux generated from the coil 1122 excited due to current applied thereto flows from one of the pair of out-stator salient poles 1121a of the out-stator core 1121 through the salient pole 1111 of the out-rotor 1110 and flows to the other out-stator salient pole 1121a, as shown by an arrow of FIG. 6.

In addition, the magnetic flux flows from one of the pair of in-stator salient poles 1125a of the in-stator core 1125 through the salient pole 1131 of the in-rotor 1130 and flows to the other in-stator salient pole 1125a.

Through the above-mentioned configuration, the magnetic flux flows through a short path in both of the out-rotor 1110 and the in-rotor 1130, such that core loss may be reduced, and the switched reluctance motor is implemented to have double rotors, such that a high efficiency torque and output may be obtained and a flow of the magnetic flux may be balanced.

In addition, the out-rotor may further include a sound proofing material (not shown) filled between the plurality of salient poles, wherein the sound proofing material is made of a non-magnetic material or an insulating material.

In addition, in the switched reluctance motor 1100 according to the first preferred embodiment of the present invention, six out-stator cores 1121 are formed at equipitch along an outer peripheral surface of the stator 1120 in a circumferential direction thereof, six in-stator cores 1125 are formed at equipitch along an inner peripheral surface of the stator 1120 in the circumferential direction thereof, each of the coils 1122 is wound around the out-stator salient poles 1121a and the in-stator salient poles 1125a to form a three-phase winding, ten salient poles 1111 of the out-rotor 1110 are formed at equipitch in a circumferential direction of the out-rotor 1110, and ten salient poles 1131 of the in-rotor 1130 are formed at equipitch in a circumferential direction of the in-rotor 1130.

In addition, the switched reluctance motor according to the present invention may also be implemented to have a drainage structure in which twelve in-stator cores and twelve out-stator cores are formed at equipitch in the circumferential direction of the stator and twenty salient poles of the out-rotor and twenty salient poles of the in-rotor are formed at equipitch in the circumferential direction.

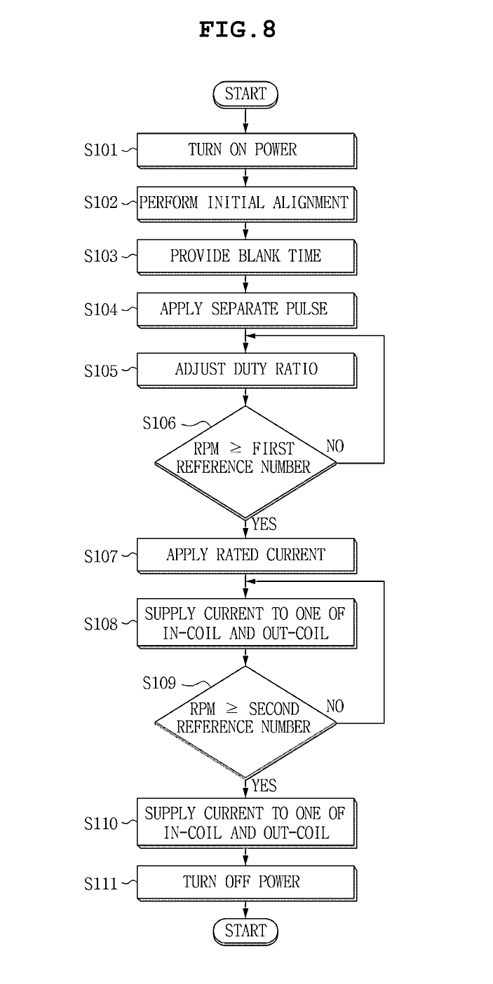

FIG. 8 is a flow chart of a method of driving a switched reluctance motor according to the first preferred embodiment of the present invention.

First, when power is turned on (S101), initial alignment is performed (S102). The reason why the initial alignment is performed is that there is a point at which a torque is zero due to a salient pole of a rotor and a stator of an SRM. That is, this is to solve a problem that parking is abnormally performed due to repulsive force between salient poles of the stator and the rotor.

Here, as a method of performing the initial alignment, a method of temporally applying current to a coil by allowing a switch driving unit to output a large number of small pulses to upper and lower switch devices may be used.

After the initial alignment is finished in S102, a predetermined blank time is provided so that the rotor is positioned at a normal parking position (S103). According to the preferred embodiment of the present invention, it is assumed that the blank time is about 1 second.

After the rotor is positioned at the normal parking position through the above-mentioned operations, the switch driving unit applies a large pulse (a separation pulse), that is, a large amount of current to the coil so that the rotor may be separated from the parking position (S104).

When an instantaneous torque is generated by applying the separation pulse to the coil as described above, the rotor starts to rotate, the switch driving unit sequentially applies a driving control signal to the respective phase switch devices, allows a power supply unit to supply maximum current to the SRM to rotate the rotor, and continuously increase a duty ratio of the driving control signal to increase a rotational speed of the rotor (S105).

Here, the meaning that the duty ratio is increased is that a turn-on time of the upper and lower switch devices is increased, which means that more current flows in the coil, such that the rotor more rapidly rotates.

Then, a rotational speed and a phase of the rotor are sensed using a photo sensor, such that revolutions per minute (RPM) of the motor is compared with a first reference number (S106).

As a comparison result of S106, when the sensed RPM of the motor is more rapid than the first reference number (for example, 200 rpm), the switch driving unit judges that the motor enters a high efficiency period and controls the power supply unit to convert current applied to the SRM from the maximum current into rated current and supply the rated current (S107).

Thereafter, the switch driving unit continuously increases the duty radio of the control signal to increase the rotational speed of the rotor (S108).

Here, the meaning that the duty ratio is increased is that a turn-on time of the upper and lower switch device is increased, which means that more current flows in the coil, such that the rotor more rapidly rotates.

Then, a rotational speed and a phase of the rotor are sensed using the photo sensor, such that RPM of the motor is compared with a second reference number (S109).

As a comparison result of S109, when the sensed RPM of the motor is more rapid than the second reference number (for example, 600 rpm), the switch driving unit judges that the motor enter a high speed period to supply a turn-on control signal only to switch devices corresponding to in-coils and out-coils among the respective phase switch devices, thereby supplying the current only to the in-coils or the out-coils (S110).

When the RPM of the motor is the second reference number or less, the switch driving unit continuously performs a process of adjusting the duty ratio.

Meanwhile, when external power is turned off (S111), the driving of the switched reluctance motor ends. Thereafter, it is judged whether the external power is again turned on (S101) and when the external power is turned on, the above-mentioned process is repeated.

As set forth above, according to the preferred embodiment of the present invention, since the in-rotor and the out-rotor are individually driven, a control may be optimally performed for each period according to a driving state including the high torque period, the high efficiency period, and the high speed period.

Particularly, according to the preferred embodiment of the present invention, only any one of the in-rotor and the out-rotor is driven in the high speed period, such that efficient driving may be performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An apparatus of driving a switched reluctance motor, the apparatus comprising:
a power supply unit supplying direct current (DC) current;
N pairs of coils each inducing a magnetic field according to the current supplied from the power supply unit to provide driving force to the switched reluctance motor and connected in parallel with each other;
N pairs of upper switch devices each connected in series with an upper portion of each of the N pairs of coils to open or close the DC current supplied from the power supply unit;
N pairs of lower switch devices each connected in series with a lower portion of each of the N pairs of coils to open or close current passing through the N pairs of coils;
2N first freewheel diodes each having one terminal connected to a connection point between the lower portion of each of the N pairs of coils and each of the N pairs of lower switch devices and the other terminal connected to a power supply terminal;
2N second freewheel diodes each connected between the upper portion of each of the N pairs of coils and a ground; and
a switch driving unit providing a driving control signal to the N pairs of upper switch devices and the N pairs of lower switch devices to sequentially supply the current to the N pairs of coils.

2. The apparatus as set forth in claim 1, further comprising a capacitor smoothing the DC current supplied from the power supply unit to supply the smoothed DC current to the N pairs of coils and charged with residual current of the N pairs of coils at the time of turn-off of the N pairs of upper switch devices and the N pairs of lower switch devices

3. The apparatus as set forth in claim 1, wherein the switch driving unit detects revolutions per minute (RPM) of the switched reluctance motor and controls the power supply unit to allow maximum power to be supplied when the RPM of the switched reluctance motor is smaller than a first reference number.

4. The apparatus as set forth in claim 3, wherein the switch driving unit detects the RPM of the switched reluctance motor and controls the power supply unit to allow rated power to be supplied when the RPM of the switched reluctance motor is larger than the first reference number.

5. The apparatus as set forth in claim 1, wherein the switch driving unit detects the RPM of the switched reluctance motor and provides the driving control signal to the N pairs of upper switch devices and the N pairs of lower switch devices so that the current flows only in any one coil of each pair of coils with respect to the N pairs of coils when the RPM of the switched reluctance motor is larger than a second reference number.

6. The apparatus as set forth in claim 1, wherein the switched reluctance motor includes:
an out-rotor provided with a plurality of salient poles protruded at equidistance along an inner peripheral surface thereof;
an in-rotor provided with a plurality of salient poles protruded at equidistance along an outer peripheral surface thereof; and
a stator provided in the out-rotor, having the in-rotor rotatably provided at an inner peripheral portion thereof, and a plurality of out-stator cores each including a pair of out-stator salient poles protruded toward the salient pole of the out-rotor and an out-stator yoke connecting the pair of out-stator salient poles to each other and supporting the pair of out-stator salient poles and a plurality of in-stator cores each including a pair of in-stator salient poles protruded toward the salient pole of the in-rotor and an in-stator yoke connecting the pair of in-stator salient poles to each other and supporting the pair of in-stator salient poles, and wherein each of the N pairs of coils is wound around the out-stator salient poles and the in-stator salient poles.

7. The apparatus as set forth in claim 6, wherein the out-stator core has a pi (π) shape.

8. The apparatus as set forth in claim 6, wherein six out-stator cores are formed at equipitch along an outer peripheral surface of the stator in a circumferential direction thereof, six in-stator cores are formed at equipitch along an inner peripheral surface of the stator in the circumferential direction thereof, each of the coils is wound around the out-stator salient poles and the in-stator salient poles to form a three-phase winding, ten salient poles of the out-rotor are formed at equipitch in a circumferential direction of the out-rotor, and ten salient poles of the in-rotor are formed at equipitch in a circumferential direction of the in-rotor.

9. A method of driving a switched reluctance motor, the method comprising:
(A) controlling, in the switch driving unit, N pairs of upper switch devices each connected in series with an upper portion of each of N pairs of coils of the switched reluctance motor and N pairs of lower switch devices each connected in series with a lower portion of each of the N pairs of coils to apply a separation pulse to the N pairs of coils, thereby starting up the switched reluctance motor; and
(B) controlling, in the switch driving unit, the N pairs of upper switch devices and the N pairs of lower switch devices to supply maximum current to the N pairs of coils of the switched reluctance motor, thereby rotating the switched reluctance motor.

10. The method as set forth in claim 9, further comprising, before step (A), (C) controlling, in the switch driving unit, the N pairs of upper switch devices and the N pairs of lower switch devices to initially align the switch reluctance motor when power is supplied from a power supply unit.

11. The method as set forth in claim 10, further comprising, after step (C), (D) providing a predetermined blank time so that a rotor of the switched reluctance motor is positioned at a normal parking position.

12. The method as set forth in claim 9, further comprising:
(E) detecting, in the switch driving unit, RPM of the switched reluctance motor and comparing the RPM of the switched reluctance motor with a first reference number; and
(F) controlling, in the switch driving unit, a power supply unit to supply rated current to the N pairs of coils when the RPM of the switched reluctance motor is larger than the first reference number.

13. The method as set forth in claim 12, further comprising:
(G) detecting, in the switch driving unit, the RPM of the switched reluctance motor and comparing the RPM of the switched reluctance motor with a second reference number; and
(H) controlling, in the switch driving unit, the N pairs of upper switch devices and the N pairs of lower switch devices so that current flows only in any one coil of each pair of coils with respect to the N pairs of coils when the RPM of the switched reluctance motor is larger than the second reference number.
